(19) United States
(12) Patent Application Publication
(10) Pub. No.: US 2013/0012425 A1
(43) Pub. Date: Jan. 10, 2013

(54) Detergent Composition

(76) Inventors: Jesse Jefferis, Wayne, MI (US); Kenneth Zack, Wyandotte, MI (US)

(21) Appl. No.: 13/577,867

(22) PCT Filed: Feb. 9, 2011
(86) PCT No.: PCT/US11/24217

§ 371 Date: Sep. 25, 2012

Related U.S. Application Data
(60) Provisional application No. 61/302,785, filed on Feb. 9, 2010.

(51) Int. Cl. C11D 3/60

(52) U.S. Cl. 510/230; 510/229

(57) ABSTRACT

A detergent composition comprises a chelating component, a metal citrate, and a metal carbonate. At least one of following two conditions is typically true: X=(2.29*a1)+(2.51*a2)+(2.26*b)+(2.75*c)+(−0.15*a1*b)+(0.26*a2*b)+(1.33*a2*c); and/or Y=(4.00*a1)+(3.76*a2)+(3.70*b)+(3.10*c)+(−4.11*a1*b)+(−1.57*a2*b)+(0.97*a2*c). In the preceding X and Y conditons, 0<X≦2.5, 0<Y≦3.5, at least one of a1 and a2 is greater than zero and less than 1.0, 0<b<1.0, 0<c<1.0, and a1+a2+b+c=1.0. Further, X is the filming performance of the detergent composition and Y is the spotting performance of the detergent composition. a1 is the weight fraction of the chelating component a1), a2 is the weight fraction of the chelating component a2), b is the weight fraction of the metal citrate, and c is the weight fraction of the metal carbonate. The weight fractions are based on the total amount of the chelating component, metal citrate and metal carbonate present in the detergent composition.

### CROSS REFERENCE TO RELATED APPLICATIONS

This application claims the benefit of U.S. Provisional Patent Application Ser. No. 61/302,785, filed on Feb. 9, 2010, which is incorporated herewith by reference in its entirety.

### FIELD OF THE INVENTION

The present invention generally relates to a detergent composition and, more specifically, to a detergent composition that includes a chelating component, a metal citrate and a metal carbonate.

### DESCRIPTION OF THE RELATED ART

Hard water includes calcium and magnesium (i.e., hardness minerals), which cause spotting of dishware, glassware and tableware. Detergent compositions, such as automatic dishwasher detergents (ADDs), typically employ builder components that are used to soften hard water. Builder components, which typically include chelating agents and/or sequestering agents, combine with the hardness minerals and hold them in solution. Generally, when “high-performance” builder components are employed, the hardness minerals cannot combine with food soils. In addition, the hardness minerals and the hardness mineral/food soil combination tend to leave insoluble spots and/or film on dishware, glassware and tableware. Spotting is especially a concern with glassware, such as drinking glasses, since spotting is aesthetically displeasing, and calls into question cleanliness of the glassware. Filming, or “milkiness”, of glassware poses similar problems.

Conventional builder components including phosphorus-containing builder components, such as phosphates and phosphonates, are especially useful at reducing spotting of glassware. Some of these phosphorus-containing builder components, such as trisodium phosphate and sodium tripolyphospate (STPP), have set a benchmark in the dishwasher detergent industry as having excellent performance when it comes to reducing spotting and filming of glassware. As such, phosphorus-containing builder components are generally considered to be “high-performance” builders.

Although phosphorus-containing builder components have set a performance benchmark in the industry, phosphorus has been targeted as a component to be phased out of detergent compositions because of potential environmental concerns. As just one example, the Soap and Detergent Association (SDA) and its members are seeking agreements with legislatures across the country to limit the amount of phosphorus in ADDs for home use to 0.5% (virtual elimination), effective Jul. 1, 2010. In the agreements, the 0.5% limit is for allowing trace amounts of phosphorus.

In a recent Consumer Reports study, eighteen ADDs of various forms including powder, packet, sachet and liquid ADDs were evaluated. In the study, both dirty dishes and pots were washed in dishwashers, with redepositing of soil and spotting being evaluated in order to rank performance of the various ADDs. The top five performing ADDs all included phosphate builder components, i.e., “high-performance” builders. In addition, of the top five performing ADDs including phosphate builder components, only one was in liquid form, which ranked fifth. However, there still remains an opportunity to provide improved detergent compositions. Specifically, there remains an opportunity to provide improved detergent compositions having excellent cleaning performance.

### SUMMARY OF THE INVENTION AND ADVANTAGES

A detergent composition includes a chelating component, a metal citrate, and a metal carbonate. The chelating component includes a1) methylglycine-N—N-diacetic acid (MGDA) and/or the alkali salt thereof, and/or a2) N,N-bis(carboxymethyl)-L-glutamate (GLDA) and/or the alkali salt thereof. The total amount of the chelating component, metal citrate and metal carbonate present in the detergent composition is no greater than about 50 parts by weight based on 100 parts by weight of the detergent composition. Further, at least one of the following conditions is typically true: X=(2.29*a1)+(2.51*a2)+(2.26*b)+(2.75*c)+(−0.15*a1*b)+(0.26*a2*b)+(1.33*a2*c); and Y=(4.00*a1)+(3.76*a2)+(3.70*b)+(3.10*c)+(−4.11*a1*b)+(−1.57*a2*b)+(0.97*a2*c). In the preceding conditions, typically 0<X≦2.5, 0<Y≦3.5, at least one of a1 and a2 is greater than zero and less than 1.0, b is greater than zero and less than 1.0, c ranges from zero to less than 1.0, and a1+a2+b+c=1.0. Also in the preceding conditions, X represents filming performance of the composition, Y represents spotting performance of the composition, a1 is the weight fraction of the chelating component a1), a2 is the weight fraction of the chelating component a2), b is the weight fraction of the metal citrate, and c is the weight fraction of the metal carbonate, wherein the weight fractions are based on the total amount of the chelating component, metal citrate and metal carbonate present in the detergent composition.

The present invention provides a unique combination of the chelating component, metal citrate and metal carbonate. Generally, the unique combination of the aforementioned components imparts the detergent composition with excellent detergency characteristics, such as reduced filming and spotting on dishware relative to conventional compositions. The detergent composition of the present invention may be used to replace conventional automatic dishwasher detergents.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a ternary plot illustrating non-limiting a1, b and c weight fractions of X and Y conditions of the present invention;

FIG. 2 is a ternary plot illustrating non-limiting a2, b, and c weight fractions of X and Y conditions of another embodiment of the present invention; and

FIG. 3 is a ternary plot illustrating non-limiting b, c, and d weight fractions of X and Y conditions for comparison with the present invention.

### DETAILED DESCRIPTION OF THE INVENTION

The present invention provides a detergent composition. The detergent composition includes a chelating component, a metal citrate, and a metal carbonate. The detergent composition can include one or more additional components, as described further below.

The detergent composition can be used for various purposes. Typically, the detergent composition is employed as a dishwasher detergent, more typically as an automatic dishwasher detergent (ADD), which is also commonly referred to in the art as an automatic dishwashing (ADW) detergent. The detergent composition can be used for cleaning dishes, glasses, tableware, etc. The detergent composition can also be used to loosen baked and dried-on food soils by soaking (or pre-treating) dishes, glasses, tableware, etc. with the detergent composition prior to automatic dishwashing.

The detergent composition has excellent cleaning properties. Some of these properties include one or more of the following: tying-up/inactivating hardness minerals, such as calcium and magnesium; reducing surface tension to allow water to penetrate and loosen soil, such as food soil; emulsifying and/or solubilizing soils, such as greasy or oily soils; suspending and/or dispersing removed soils; saponifying oily/fatty soils, enzymatically digesting protein-based soils; removing proteinaceous and starchy soils; suppressing foam caused by protein soils, such as egg and milk; lowering surface and interfacial tensions; protecting china patterns and metals from the corrosive effects of heat and water; and neutralizing acidic soils.

In various embodiments, the detergent composition has one or more excellent cleaning properties that may include one or more described immediately below. Detergency is a cleaning property that includes the ability to break the bond between soil and a surface. Penetration and wetting are cleaning properties which allow water to surround soil particles that would otherwise repel the water. Emulsification is a cleaning property that includes the ability to break up oil based soils into small droplets that can be dispersed thoroughly. Solubilizing is a cleaning property that dissolves soil such that the soil is no longer a solid particle. Dispersing is a cleaning property which leads to spreading small soil particles throughout a solution (e.g. wash water) to prevent the soil particles from sticking to objects such as dishwasher racks, dishwasher walls, or back onto a cleaned surface (e.g. dishes, glasses and tableware).

The detergent composition is especially useful for helping water to sheet off surfaces, thus minimizing water spots and filming on the same, as described in detail further below. Film is typically formed on tableware and glassware upon evaporation of water containing solids. Solids in wash water can originate from soil load and/or soils present on dishes, glassware, etc. Typical soils include proteinaceous, fatty and starch-based soils. Water hardness contributes to the presence of solids typically in the form of insoluble calcium and magnesium salts. Water temperature can also affect the cleaning performance of the detergent composition, with increased temperature typically increasing cleaning performance of the detergent composition.

The detergent composition is typically a liquid, but may be a liquid/gel or a gel. In one embodiment, the detergent composition is a solid. The detergent composition can be supplied to consumers in various ways. Typically, the detergent composition is supplied to consumers in bottles or similar containers. In other embodiments, the detergent composition may be retained within a conventional packet, sachet or pouch. However, the detergent composition is typically in a free-flowing form, such as liquid from a bottle, for ease of use.

In various embodiments, the detergent composition typically has a viscosity of at least about 500, alternatively from about 1,000 to about 15,000, of from about 1,000 to about 10,000, of from about 4,000 to about 8,000, or of from about 5,000 to about 8,000, cP at 25° C. The viscosity of the detergent composition may be determined by any method known in the art. For example, the viscosity of the detergent composition may be measured using a Brookfield viscometer, a Shell cup, a Zahn cup, a parallel-plate rheometer, etc.

Those skilled in the art appreciate the gels are generally higher in viscosity relative to liquids, and/or gels have a thixotropic or non-Newtonian character relative to liquids. As such, when the detergent composition is a liquid/gel or a gel, it typically has a viscosity the same as described and exemplified immediately above, or a viscosity that is higher or lower than described and exemplified immediately above.

For ease of use, the detergent composition can be placed into a reservoir of a dishwasher by pouring the detergent composition into the reservoir which may or may not include a cover. Alternatively, the detergent composition is poured in to the dishwasher directly. When the detergent composition is in the form of a gel, it may be especially useful when the reservoir is on a door of the dishwasher, such that the gel will cling to the door thereby increasing contact with water during use of the dishwasher. It is to be appreciated that the present invention is not limited to any particular use of the detergent composition.

The detergent composition is generally biodegradable; therefore, the detergent composition may be chemically degraded via natural effectors such as soil bacteria, weather, plants and/or animals. Typically, in the context of detergent compositions, biodegradation refers to decomposition of the organic ingredients in the formulation by bacteria present in waste treatment systems, surface waters, or in soil. The biodegradability of the detergent composition reduces a possibility of pollution and formation of environmental hazards and is typically dependent on components of the detergent composition, e.g. the chelating component. In addition, there may be a reduced risk to individuals who manufacture and use the detergent composition relative to chemical exposure.

With regard to the chelating component, the chelating component includes a1) methylglycine-N—N-diacetic acid (MGDA) and/or an alkali salt thereof, and/or a2) N,N-bis(carboxymethyl)-L-glutamate (GLDA) and/or the alkali salt. Said another way, the chelating component can be a1), a2), or a combination thereof. Each of a1) and a2) may be referred to herein as a chelating agent.

MGDA is also commonly referred to in the art as methylglycine diacetate whereas GLDA is also commonly referred to in the art as glutamic acid diacetate. For a1), the alkali salt is typically a sodium salt of MGDA, such as Na₃.MGDA, which is also referred to in the art as methylglycine diacetate, trisodium salt. For a2), the alkali salt is typically a sodium salt of GLDA, such as tetrasodium L-glutamic acid, N,N-diacetic acid or Na₄.GLDA.

In certain embodiments, the chelating agent of the chelating component typically includes MGDA, or Na₃.MGDA, or mixtures thereof, and more typically, the chelating agent of the chelating component is Na₃.MGDA. In other embodiments, the chelating agent of the chelating component typically includes GLDA, or Na₄.GLDA, or mixtures thereof. Even more typically, the chelating agent of the chelating component is Na₄.GLDA. The chelating agent can also be referred to in the art as a sequestering agent. The chelating component can also be referred to in the art as a builder component. As used hereinafter, the acronym MGDA is generally meant to include either MGDA, or an alkali salt of MGDA, (e.g. Na₃.MGDA), or mixtures thereof. Likewise, the acronym GLDA is generally meant to include either GLDA, or an alkali salt of GLDA. It is to be appreciated that the chelating component can include a combination of MGDA and GLDA, as described further below.

Typically, the chelating component is aqueous, such that the chelating component includes water and the chelating agent, e.g. water and MGDA. When the chelating component is aqueous and when MGDA is employed, the MGDA is typically present in the chelating component in an amount of from about 35 to about 95, more typically from about 35 to about 83, even more typically about 35 to about 45, and yet even more typically about 40, parts by weight, each based on 100 parts by weight of the chelating component. In other embodiments where GLDA is employed, the chelating component can similarly be aqueous wherein the GLDA is present in similar amounts as described above for MGDA although the GLDA is yet even more typically present in the chelating component in an amount of about 47 parts by weight based on 100 parts by weight of the chelating component. It is to be appreciated that the chelating component may also be in the form of a powder. Water may be added to the detergent composition as a separate component. It is also to be appreciated that the chelating component may also be present in any amount calculated according to one or more of the formulas or conditions described in detail below. Amounts of the other components can also be determined according to one or more of the formulas or conditions.

Controlling the amount of water present within the detergent composition is useful for controlling viscosity of the detergent composition, which is described further below. Typically, water is present in the detergent composition in an amount of from about 50 to about 90, more typically from about 60 to about 80, and even more typically about 70, parts by weight, each based on 100 parts by weight of the detergent composition. It is to be appreciated that viscosity of the detergent composition can be controlled by other means in addition or alternate to use of water, such as by the use of one or more thickeners.

Examples of suitable chelating components, for purposes of the present invention, are commercially available from BASF Corporation of Florham Park, N.J., under the trade name TRILON® M, such as TRILON® M liquid. Further examples of suitable chelating components, for purposes of the present invention, are commercially available from AkzoNobel of Chicago, Ill., under the trade name DISSOLVINE® GL. Other examples of suitable chelating components, for purposes of the present invention, are described in U.S. Pat. No. 5,786,313 to Schneider et al., the disclosure of which is incorporated herein by reference in its entirety to the extent that the disclosure does not conflict with the general scope of the present invention described herein.

The chelating agent, e.g. Na₃.MGDA, is useful for inactivating hardness minerals and/or metallic ions in water, such as water encountered in conventional residential, commercial, industrial and institutional dishwashers. Hardness of water is generally imparted to the water by minerals, such as calcium and magnesium. Other metallic ions include dissolved metals, such as iron and manganese.

Typically, MGDA and GLDA inactivate hardness minerals (e.g. calcium and magnesium) and iron and manganese without precipitation. Water softening without precipitation, i.e., by sequestration, distinguishes MGDA and GLDA from other compounds such as sodium carbonate, which generally soften by precipitation of the hardness minerals. MGDA and GLDA generally combine with hardness minerals and hold them in solution such that the hardness minerals cannot combine with (food) soils. In addition, neither the hardness minerals themselves nor the hardness mineral/soil combination typically leave insoluble spots or film on dishes and the like.

Without being bound or limited by any particular theory, it is believed that the low molecular weight of MGDA imparts MGDA with greater chelating/sequestering efficiency relative to other chelating agents or components, such as GLDA. Those skilled in the art can appreciate that MGDA and GLDA are both generally classified as aminocarboxylates. It is to be appreciated that the detergent composition is not limited solely to the use of MGDA and/or GLDA, and may include one or more chelating agents in addition to MGDA and/or GLDA, so long as such additional chelating agents remain within the scope of the present invention.

The metal citrate is typically a metal salt of citric acid. As such, the metal citrate may include some amount of citric acid itself, such as trace amounts of citric acid. It is to be appreciated that citric acid may also be used as an additional component in the detergent composition, as described further below.

The metal citrate sequesters hardness minerals. The metal citrate is also useful as a builder and as an alkaline buffer in the detergent composition. Surprisingly, it has been found that the metal citrate also has a synergy with the chelating component, as described further below. Suitable grades of metal citrate are commercially available from a variety of suppliers. The metal of the metal citrate may be any alkali metal or alkaline earth metal. Typically, the metal is sodium (Na) or potassium (K), such that the metal citrate is sodium citrate or potassium citrate. However, the metal is not limited and may alternatively include a transition metal. In certain embodiments, the metal citrate is sodium citrate.

The metal carbonate may also include any metal known in the art. Typically, the metal of the metal carbonate may be any alkali metal or alkaline earth metal. Typically, the metal is sodium (Na) or potassium (K), such that the metal carbonate is sodium citrate or potassium carbonate. However, the metal is not limited and may alternatively include a transition metal. In one embodiment, the metal carbonate is further defined as sodium carbonate which is also commonly referred to in the art as “soda ash,” especially when in an anhydrous form, or as “washing soda” when in a hydrated/crystalline form. Because metal carbonates are generally strong alkaline salts, the metal carbonate is useful as a builder and as a source of alkalinity in the detergent composition. The metal carbonate provides alkaline cleaning power and also softens water by precipitating the hardness minerals out of solution. Specifically, since metal carbonates tend to be precipitating builders, the metal carbonates usually soften water by converting hardness minerals to an insoluble form in contrast to softening by sequestration, i.e., without precipitation. Typically, precipitating builders soften or inactivate hardness salts by removing mainly calcium as insoluble compounds. In certain embodiments, the metal carbonate is sodium carbonate.

The metal carbonate is also useful for breaking down and helping to remove proteinaceous and starchy soils from glassware, dishes, and the like. Surprisingly, it has been found that the metal carbonate also has a synergy with the chelating component, as described further below. Suitable grades of metal carbonate are commercially available from a variety of suppliers.

Typically, the total amount of the chelating component, metal citrate and metal carbonate present in the detergent composition is no greater than about 50, more typically no greater than about 45, and even more typically no greater than about 40, parts by weight, each based on 100 parts by weight of the detergent composition. Typically, the total amount of the chelating component, metal citrate and metal carbonate present in the detergent composition is at least about 25, more typically at least about 30, and even more typically at least about 35, parts by weight, each based on 100 parts by weight of the detergent composition. In specific embodiments, the total amount of the chelating component, metal citrate and metal carbonate present in the detergent composition is typically from about 35 to about 45, more typically from about 37.5 to about 42.5, and even more typically about 40, parts by weight, each based on 100 parts by weight of the detergent composition.

Regardless of the total amount of the chelating component, metal citrate and metal carbonate present in the detergent composition, at least one of the following conditions is typically true: X=(2.29*a1)+(2.51*a2)+(2.26*b)+(2.75*c)+(−0.15*a1*b)+(0.26*a2*b)+(1.33*a2*c); and Y=(4.00*a1)+(3.76*a2)+(3.70*b)+(3.10*c)+(−4.11*a1*b)+(−1.57*a2*b)+(0.97*a2*c). In the preceding conditions, typically 0<X≦2.5, 0<Y≦3.5, at least one of a1 and a2 is greater than zero and less than 1.0, b is greater than zero and less than 1.0, c ranges from zero to less than 1.0, more typically c is greater than zero and less than 1.0, and a1+a2+b+c=1.0.

Also in the aforementioned conditions:

a1 is the weight fraction of the chelating component a1) (i.e., MGDA);

a2 is the weight fraction of the chelating component a2) (i.e., GLDA);

b is the weight fraction of the metal citrate; and

c is the weight fraction of the metal carbonate, wherein the weight fractions are based on the total amount of the chelating component, metal citrate and metal carbonate present in the detergent composition. As used herein, “a1” can also refer to “a” alone, such that description of a and a1 is interchangeable for purposes of describing the chelating agent when MGDA. As introduced above, a synergy between the combination of the chelating component, metal citrate and metal carbonate present within the detergent composition exists in the present invention. Typically, the aforementioned conditions are related to testing pursuant to ASTM D 3556-85, which is entitled “Standard Test Method for Deposition on Glassware During Mechanical Dishwashing”, and/or CSPA DCC-05A, which is entitled “Deposition on Glassware During Mechanical Dishwashing.” However, the testing conditions are not dependent on these testing methods and the instant invention is not limited to use of these testing methods. Additional testing parameters are further described in the Examples below.

Moreover, in the aforementioned conditions, X represents filming performance of the detergent composition, such as filming performance when washing glassware (e.g. drinking glasses), where a lower number is better relative to a higher number. In other words, a filming performance of 5.0 is considered to be worse than 4.5, 4.5 is considered to be worse than 4.0 and so on, where filming of the glassware is reduced as X decreases. One way to articulate the performance numbers is to use a five point scale comprising five levels of performance. The five point scale includes excellent (e.g. 1.0), very good (e.g. 2.0), good (e.g. 3.0), fair (e.g. 4.0), and poor (e.g. 5.0), filming performance. It is to be appreciated that similar scales could also be used, such as a ten point scale of filming performance.

X is generally set at a threshold of ≦2.5, based in part on extensive analysis and study of filming characteristics, described in greater detail in the EXAMPLES section below. Filming can be thought of as the level of film/milky residue left on the glassware after washing. In other embodiments, X can be set at different thresholds, such as ≦2.25, ≦2.00, ≦1.75, and so on, all the way down to zero. It is to be appreciated that X can be set at any numerical value, with or without a decimal place, generally ranging from 0 to 5.0.

Furthermore, Y represents spotting performance of the detergent composition, such as spotting performance when washing glassware, where a lower number is better relative to a higher number. In other words, a spotting performance of 5.0 is considered to be worse than 4.5, 4.5 is considered to be worse than 4.0 and so on, where spotting of the glassware is reduced as Y decreases. One way to articulate the performance numbers for spotting performance is to use the five point scale described and exemplified above.

Y is generally set at a threshold of ≦3.5, based in part on extensive analysis and study of filming characteristics, described in greater detail in the EXAMPLES section below. Spotting can be thought of as the level-of/number-of spots left on the glassware after washing. In other embodiments, Y can be set at different thresholds, such as ≦3.25, ≦3.00, ≦2.75, and so on, all the way down to zero. It is to be appreciated that Y can be set at any numerical value, with or without a decimal place, generally ranging from 0 to 5.0. In addition, it is to be appreciated that the present invention can employ any combination of X and Y threshold values, where the X and Y values may be the same or different.

As can be appreciated with reference to the X and Y conditions above, weighting factors of each of the chelating component, metal citrate and metal carbonate influences the resulting X and Y values. For example, in the X condition, the weight fraction of the chelating component a1) present in the detergent composition (i.e., a1) may impart a weighting factor of 2.29 to the X condition. Specifically, the weight fraction of the chelating component a1) present in the detergent composition typically increases X, because it may be multiplied by 2.29, which is generally undesirable as described above where lower X values are generally preferred. As shown in the X condition, the weight fraction of the metal carbonate (i.e., c) typically has the greatest impact on increasing X (because of the 2.75 weighting factor), followed by the weight fraction of the chelating components a1) and a2), and then followed by the weight fraction of the metal citrate (i.e., b), which typically has the least impact on increasing X (because of the 2.26 weighting factor).

However, with reference to the X condition, it is illustrated that a synergistic effect exists between the weight fractions of the chelating component and the metal citrate. The specific combination of the chelating component and metal citrate present in the detergent composition typically decreases X, which is desirable for the reasons described above. As shown in the X condition, the combination (i.e., the mathematical product) of the weight fractions a1 and b typically has a negative weighting factor of −0.15. As such, specific combinations of the chelating component and the metal citrate encompassed by the X and Y conditions typically improve filming performance of the detergent composition.

With regard to the Y condition, the weight fraction of the chelating component a1) present in the detergent composition typically increases Y, because it is multiplied by 4.00, which is generally undesirable as described above where lower Y values are generally preferred. As shown in the Y condition, the weight fraction of the chelating component a1) (i.e., a1) typically has the greatest impact on increasing Y, followed by the weight fraction of the chelating component a2) (i.e., a2, because of the 3.76 weighting factor), the metal citrate (i.e., b, because of the 3.70 weighting factor), and then followed by the weight fraction of the metal carbonate (i.e., c), which typically has the least impact on increasing Y (because of the 3.10 weighting factor).

However, with reference to the Y condition, it is illustrated that a synergistic effect exists between the weight fractions of the chelating component a1) and the metal citrate. The specific combination of the chelating component a1) and metal citrate present in the detergent composition typically decreases Y, which is desirable for the reasons described above. As shown in the Y condition, the combination (i.e., the mathematical product) of the weight fractions a1 and b typically has a negative weighting factor of −4.11, which is greater in (absolute) value relative to any one of the weighting factors attributable to each of the individual components alone. For example, if one were to average the weighting factors of the a1 and b weight fractions, one would find that the average equals 3.85 (i.e., (4.00+3.70)/2), which is less than |-4.111. As such, specific combinations of the chelating component and the metal citrate encompassed by the X and Y conditions improve spotting performance of the detergent composition. It is to be appreciated that the weighting factors can each be simplified further, such as by rounding up or down. Generally, including one more decimal places for each of the weighting factors increases accuracy of the weight fractions a1, a2, b and c, which are determined within the confines of the X and Y conditions.

In view of the foregoing, and as reinforced further below in the EXAMPLES section, based on the X and Y conditions, a synergy exists between the specific combination of the chelating component and metal citrate that increases filming performance of the detergent composition, i.e., by reducing filming on washed wares washed utilizing the detergent composition of the present invention. Further, a synergy exists between the specific combination of the chelating component and metal citrate that increases spotting performance of the detergent composition, i.e., by reducing spotting on washed wares washed utilizing the detergent composition of the present invention.

By choosing specific weight fractions, i.e., a1, a2, b and c, that comply with confines of the X and Y conditions above, the total amount of each of the chelating component(s), metal citrate and metal carbonate present in the detergent composition can be determined. For example, if the total amount of the chelating component a1), metal citrate and metal carbonate present in the detergent composition is about 40 parts by weight based on 100 parts by weight of the detergent composition, and a1, b and c are each equal to about ⅓, then the chelating component a1), metal citrate and metal carbonate are each present in an amount of about 13.33 based on 100 parts by weight of the detergent composition, i.e., ⅓*40=about 13.33. Under these a1, b and c weight fraction values of ⅓ each, X equals about 2.42 and Y equals about 3.14. It is to be appreciated that various combinations of a1, a2, b and c weight values can be used to meet the confines of the X and Y conditions. In certain embodiments, as alluded to above, the detergent composition includes only a1) (i.e., MGDA), only a2) (i.e., GLDA), or a combination of a1) and a2) as the chelating component.

In certain embodiments, 0.250≦a1≦0.675, 0.275≦a2≦0.675, 0.325≦b≦0.750, and 0<c≦0.175. It is to be appreciated that a1, a2, b and c can each individually be set at any numerical value within the confines of the X and Y conditions. In addition, it is to be appreciated that the present invention can employ any combination of a1, a2, b and c values within the confines of the X and Y conditions.

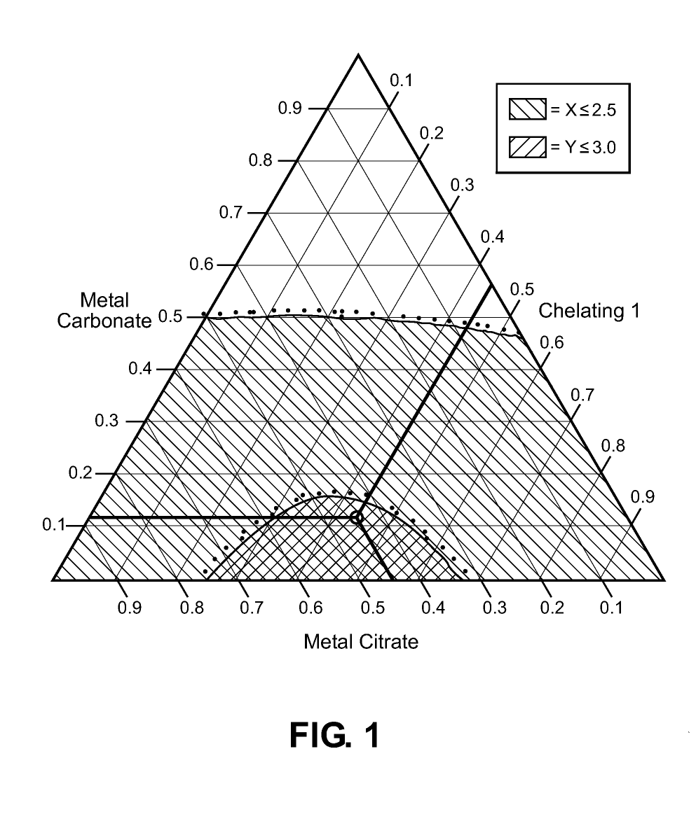

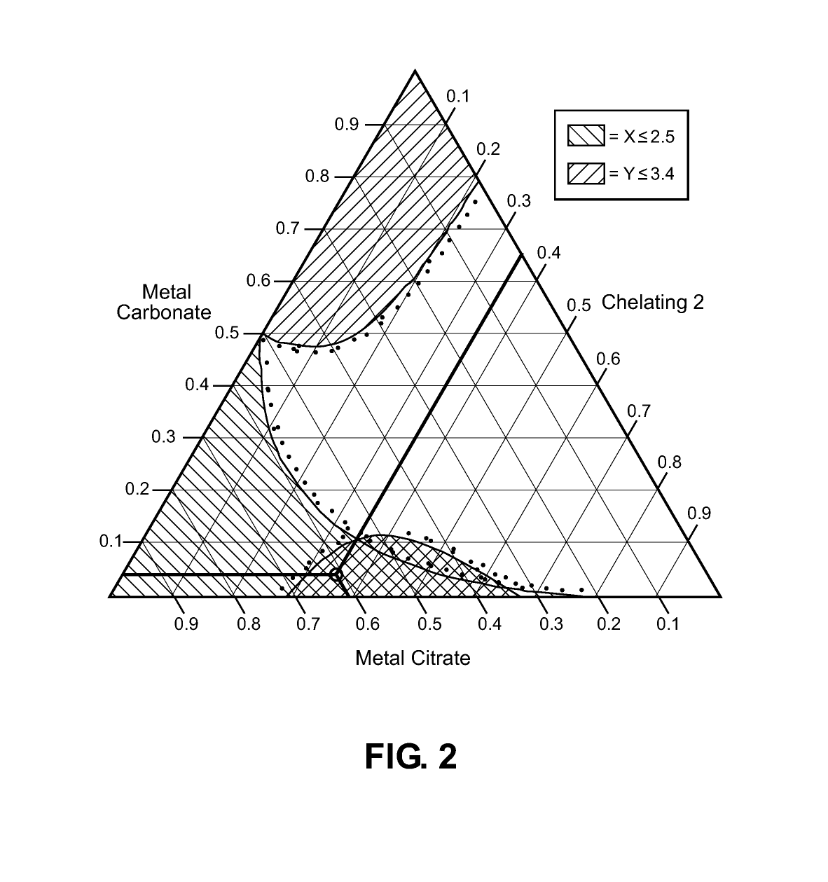

Specific non-limiting embodiments of the present invention include: a1=0.49, b=0.48 and c=0.03; a=0.60, b=0.20 and c=0.20; a1=0.068, b=0.522 and c=0.41; a1=0.33, b=0.33 and c=0.03. Additional examples of specific values for a1 (“Chelating 1”, b and c, within the confines of the X and Y conditions) include those that can be obtained by referring to the ternary plot of FIG. 1. Additional examples of specific values for a2 (“Chelating 2”, b and c, within the confines of the X and Y conditions) include those that can be obtained by referring to the ternary plot of FIG. 2.

The chelating component is typically present in the detergent composition in an amount of from about 10 to about 60, more typically from about 20 to about 50, and even more typically about 30, parts by weight, each based on 100 parts by weight of the detergent composition. The metal citrate is typically present in the detergent composition in an amount of from about 10 to about 60, more typically from about 20 to about 50, and even more typically about 30, parts by weight, each based on 100 parts by weight of the detergent composition. The metal carbonate is typically present in the detergent composition in an amount of from about 10 to about 60, more typically from about 20 to about 50, and even more typically about 30, parts by weight, each based on 100 parts by weight of the detergent composition.

As introduced above, the detergent composition can further comprise one or more additional components in addition to the chelating component, metal citrate and metal carbonate. For example, the detergent composition can further comprise, but is not limited to, a nonionic surfactant, a polymeric dispersant, a builder (different than the aforementioned builders), or a filler, or combinations thereof. It is to be appreciated that other components may also be used, as long as they do not conflict with the general scope of the present invention described herein.

Typically, the nonionic surfactant includes an alcohol alkoxylate. The nonionic surfactant lowers the surface tension of water such that it will more quickly wet out surfaces and soils. As such, water can better sheet off dishes and not dry leaving spots. The nonionic surfactant can also help remove and emulsify fatty soils like butter and cooking fat. Examples of suitable nonionic surfactants, for purposes of the present invention, are commercially available from BASF Corporation, under the trade name PLURAFAC®, such as PLURAFAC® SLF-180, PLURAFAC® LF 400, and PLURAFAC® RA 30. If employed, PLURAFAC® SLF-180 is especially useful for emulsification of oily soils.

If employed, the nonionic surfactant is typically present in the detergent composition in an amount of from about 1 to about 15, more typically from about 5 to about 10, even more typically less than about 5, and yet even more typically from about 1 to about 2, parts by weight, each based on 100 parts by weight of the detergent composition. It is to be appreciated that the detergent composition may include a combination of two or more different nonionic surfactants.

Typically, the polymeric dispersant includes polyacrylic acid (PAA). The polymeric dispersant typically keeps particles of soil that have been removed from wares in a dispersed or suspended state such that the particles are more readily removed from the dishwasher when the wash water is pumped out. The polymeric dispersant can also be useful as a thickener. Examples of suitable polymeric dispersants, for purposes of the present invention, are commercially available from BASF Corporation under the trade name SOKALAN®, such as SOKALAN® PA 30 CL, and from Lubrizol Corporation of Wickliffe, Ohio, under the trade name CARBOPOL®, such as CARBOPOL® 676. If employed, CARBOPOL® 676 is useful as a thickener.

If employed, the polymeric dispersant is typically present in the detergent composition in an amount of from about 1 to about 15, more typically from about 5 to about 10, even more typically less than about 5, and yet even more typically from about 1 to about 2, parts by weight, each based on 100 parts by weight of the detergent composition. It is to be appreciated that the detergent composition may include a combination of two or more polymeric dispersants.

The builder is typically a supplemental builder different than each of the chelating component, metal citrate and the metal carbonate. Typically, the builder includes a silicate, more typically a metal silicate (e.g. sodium silicate), and even more typically a metal metasilicate (e.g. sodium metasilicate). Examples of other suitable builders, for purposes of the present invention, include, but are not limited to, metal bicarbonates and metal aluminosilicates (e.g. sodium bicarbonate and sodium aluminosilicate).

As introduced above, builders have a number of functions, but principally inactivate hardness minerals present in hard water. This is accomplished either by sequestration, i.e. holding hardness minerals in solution, by precipitation, or by ion exchange. Builders can also supply (buffered) alkalinity to assist cleaning, especially of acid soils, provide buffering such that alkalinity is maintained at an effective level, aid in keeping removed soil from redepositing during washing, and emulsify oily and greasy soils. If employed, metal silicates are also useful as corrosion inhibitors, can provide protection of washer metal parts by acting as a lubricant, and can provide protection for china patterns and metal tableware/utensils. Another example of a suitable corrosion inhibitor, for purposes of the present invention, is zinc sulfate. Examples of suitable supplemental builders, for purposes of the present invention, are commercially available from BASF Corporation and Fisher Scientific of Pittsburgh, Pa.

If employed, the supplemental builder is typically present in the detergent composition in an amount of from about 1 to about 40, more typically from about 1 to about 20, and even more typically about 10, parts by weight, each based on 100 parts by weight of the detergent composition. It is to be appreciated that the detergent composition may include a combination of two or more supplemental builders.

The filler typically includes a metal sulfate (e.g. sodium sulfate). The filler provides stability or desirable physical properties to the detergent composition without necessarily impacting performance of the detergent composition. Examples of suitable fillers, for purposes of the present invention, are commercially available from BASF Corporation. It is to be appreciated that water can be a filler.

If employed, the filler is typically present in the detergent composition in an amount of from about 10 to about 90, more typically from about 40 to about 80, and even more typically about 70, parts by weight, each based on 100 parts by weight of the detergent composition. It is to be appreciated that the detergent composition may include a combination of two or more fillers.

The detergent composition can further comprise an enzyme component. The enzyme composition typically includes a protease, an amylase, a lipase, a cellulase, or a peroxidase, or combinations thereof. The enzyme component is useful for breaking down soil. For example, proteases are effective in breaking down proteins into smaller, less complex molecules. As another example, amylases are effective in breaking down carbohydrates. As such, the enzyme component can be useful for either removing or reducing to smaller units a broad spectrum of soils for later removal in the wash water. The chelating component of the present invention has excellent compatibility with the enzyme component, which increases performance of the detergent composition. Examples of suitable enzymes, for purposes of the present invention, are commercially available from Danisco A/S of Copenhagen, Denmark, under the trade name PROPERASE®, such as PROPERASE® L, and under the trade name PURASTAR®, such as PURASTAR® HP Am.

If employed, the enzyme component is typically present in the detergent composition in an amount of from about 0.1 to about 3, more typically from about 0.5 to about 2, and even more typically about 1, parts by weight, each based on 100 parts by weight of the detergent composition. It is to be appreciated that the detergent composition may include a combination of two or more enzymes. For example, the detergent composition can include a combination of protease and amylase.

The pH of the detergent composition can be of various numerical values. Typically, the pH of the detergent composition is no greater than 12, alternatively no greater than 9, more typically ranging from about 7 to about 9, and even more typically about 8. The pH of the detergent composition can be adjusted by the addition of acidic or basic components. Typically, too high of a pH can impact enzymes. As such, if the enzyme component is employed in the detergent composition, the pH of the detergent composition is typically no greater than about 9, more typically from about 7 to about 8.5.

The detergent composition can further comprise additional components, such as conventional additives of the art. Examples of suitable additives, for purposes of the present invention, include, but are not limited to: solvents such as ethylene glycol, ethyl alcohol and isopropanol; salts; polymers such as polyacrylates; copolymers such as copolymers of maleic acid and acrylic acid; suds/foam inhibitors; complexing agents; fragrances; perfumes; oils; preservatives; inorganic extenders; formulation auxiliaries; solubility improvers; opacifiers; dyes; pigments; activators; catalysts; electrolytes; soaps; detergents; borax; acids such as amidosulfonic acid, citric acid, lactic acid and acetic acid; alkali donors such as hydroxides; interface-active ethyleneoxy adducts; and combinations thereof.

If employed, suitable soil release polymers include, but are not limited to, amphiphilic graft polymers or copolymers of vinyl esters and/or acrylic esters onto polyalkylene oxides or modified celluloses, such as methylcellulose, hydroxypropylcellulose, and carboxymethylcellulose, and combinations thereof. If employed, suitable suds/foam inhibitors include, but are not limited to, organopolysiloxanes, silica, paraffins, waxes, microcrystalline waxes, and combinations thereof. The additive or additives can be employed in various amounts. It is to be appreciated that the additives may be used in addition or alternate to the other components described above, e.g. the enzyme component.

The detergent composition may be free of a phosphorus-containing component and/or a linear alkylbenzene sulfonate or may include a phosphorus-containing component and/or a linear alkylbenzene sulfonate. Examples of components containing phosphorus include phosphates and phosphonates. Specific examples of typical phosphates used in the art include trisodium phosphate and sodium tripolyphospate (STPP). Trisodium phosphate is also commonly referred to in the art as orthophosphate, and is the trisodium salt of phosphoric acid. Phosphates are generally classified as salts of the various phosphoric acids.

By free of a phosphorus-containing component, it is meant that the detergent composition may be free of a purposefully added component including phosphorus, such as the addition of a phosphorus-based builder, e.g. orthophosphate. As such, it is to be appreciated that the detergent composition may include some trace amount of phosphorus, such as a trace amount of phosphorus present in one or more of the components of the detergent composition.

If trace amounts of phosphorus are present in the detergent composition, the detergent composition may include phosphorus in an amount of from about 0.50 to approaching zero (0), more typically from about 0.25 to approaching 0, and even more typically from about 0.10 to approaching 0, parts by weight, each based on 100 parts by weight of the detergent composition. In one embodiment, the detergent composition completely excludes phosphorus.

The detergent composition may also be free of linear alkylbenzene sulfonates (LABS), which is also referred to in the art as a linear alkylate sulfonate (LAS). In some embodiments, the LABS and/or LAS are surfactants. A specific example of a LAS commonly used in the art is sodium dodecyl benzene sulfonate. All LAS surfactants are generally classified as anionic surfactants.

By free of linear alkylbenzene sulfonate, it is meant that the detergent composition may be free of a purposefully added component including a linear alkylbenzene sulfonate, such as the addition of a LAS based builder, e.g. sodium dodecyl benzene sulfonate. As such, it is to be appreciated that the detergent composition may include some trace amount of linear alkylbenzene sulfonates, such as a trace amount of a linear alkylbenzene sulfonate present in one or more of the components of the detergent composition.

If trace amounts of linear alkylbenzene sulfonate are present in the detergent composition, the detergent composition may include the linear alkylbenzene sulfonate in an amount of from about 0.50 to approaching zero (0), more typically from about 0.25 to approaching 0, and even more typically from about 0.10 to approaching 0, parts by weight, each based on 100 parts by weight of the detergent composition. In one embodiment, the detergent composition completely excludes linear alkylbenzene sulfonate.

The detergent composition may be free of an anionic surfactant or may include an anionic surfactant. While LAS surfactants tend to be the most commonly used anionic surfactants, other anionic surfactants include alkane sulfonate, alkyl ethoxylate sulfate, alkyl glyceryl sulfonate, alkyl sulfate, and alpha olefin sulfonate.

If the anionic surfactant is present in the detergent composition, the detergent composition typically includes the anionic surfactant in an amount of from about 15 to approaching zero (0), more typically from about 10 to approaching 0, yet more typically from about 5.0 to approaching 0, and even more typically from about 1.0 to approaching 0, parts by weight, each based on 100 parts by weight of the detergent composition. In certain embodiments, the detergent composition completely excludes the anionic surfactant.

In various embodiments, the detergent composition is free of a chlorine-containing component. Examples of components containing chlorine include chlorine bleaches, which generally belong to a group of strong oxidizing agents, all of which have one or more chlorine atoms in their molecule. Specific examples of chlorine bleaches used in the art include chlorinated isocyanurates, chlorinated trisodium phosphate, hypochlorite, and sodium hypochlorite.

By free of a chlorine-containing component, it is generally meant that the detergent composition is free of a purposefully added component including chlorine, such as the addition of chlorine bleach, e.g. sodium hypochlorite. As such, it is to be appreciated that the detergent composition may include some trace amount of chlorine, such as a trace amount of chlorine present in one or more of the components of the detergent composition.

If trace amounts of chlorine are present in the detergent composition, the detergent composition typically includes chlorine in an amount of from about 0.50 to approaching zero (0), more typically from about 0.25 to approaching 0, and even more typically from about 0.10 to approaching 0, parts by weight, each based on 100 parts by weight of the detergent composition. Typically, the detergent composition completely excludes chlorine. Chlorine can react with the chelating component, thereby causing performance issues for the detergent composition.

In some embodiments, the detergent composition is free of a bleach component. While chlorine bleaches tend to be commonly used bleach components, other bleaches include non-chlorine bleaches, such as peroxygen compounds, which release active oxygen in wash water. Further examples of non-chlorine bleaches include perborates/sodium perborates, potassium monopersulfates, sodium percarbonates, hydrogen peroxides, and organic peracids.

If the bleach component is present in the detergent composition, the detergent composition typically includes the bleach component in an amount of from about 15 to approaching zero (0), more typically from about 10 to approaching 0, yet more typically from about 5.0 to approaching 0, and even more typically from about 1.0 to approaching 0, parts by weight, each based on 100 parts by weight of the detergent composition. In certain embodiments, the detergent composition completely excludes the bleach component.

To form the detergent composition, the components of the detergent compositions are typically blended in a vessel until a homogenous solution is obtained. Various vessels, mixers, blenders, and similar machinery known in the art can also be employed. Temperature and/or pressure can be adjusted to facilitate blending of the components of the detergent composition. It is to be appreciated that the present invention is not limited to any particular method of manufacture for forming the detergent composition. Conventional methods and apparatuses can be employed to form the detergent composition.

It is also contemplated that the instant invention may provide a builder composition and may include one or more components thereof, as described in U.S. Pat. Nos. 7,504,373 and 7,503,333, and U.S. Provisional Patent Application No. 61,302,845 and a concurrently filed PCT Application, both related to Docket Number: 10064/PF-70306 and entitled “BUILDER COMPOSITION AND METHOD OF FORMING.” The disclosures of each of these documents are expressly incorporated by reference in their entirety to the extent that the disclosures do not conflict with the general scope of the present invention described herein.

The following examples, illustrating the detergent compositions of the present invention, are intended to illustrate and not to limit the present invention.

### Examples

By way of comparison with detergent compositions of the present invention, in a recent Consumer Reports study, eighteen automatic dishwasher detergents (ADDs) of various types/forms including powder, packet, sachet and liquid ADDs were evaluated. In the Consumer Reports study, both dirty dishes and pots were washed in dishwashers, with redepositing of soil and spotting being evaluated in order to rank performance of the various ADDs. The results of the Consumer Reports study are reproduced in TABLES I and II below. TABLE I includes dish washing, pot washing, water spotting, and re-depositing results, and the average thereof, for eighteen comparative ADDs. In TABLE II, the presence (or absence) of phosphates, bleach, and/or enzymes is gathered from labels of the respective ADDs. The symbol ‘x’ indicates the presence of the component.

TABLE I

| | | | | No | | |
|---|---|---|---|---|---|---|
| Comparative | Type/ | | | Water | No | |
| Example | Form | Dishes | Pots | Spots | Redeposit | Average |
| 1 | Packet | 1.00 | 1.00 | 1.00 | 1.00 | 1.00 |
| 2 | Tablet | 2.00 | 1.00 | 1.00 | 1.00 | 1.25 |
| 3 | Powder | 2.00 | 1.00 | 1.00 | 2.00 | 1.50 |
| 4 | Tablet | 2.00 | 2.00 | 2.00 | 2.00 | 2.00 |
| 5 | Liquid | 1.00 | 3.00 | 1.00 | 2.00 | 1.75 |
| 6 | Tablet | 1.00 | 4.00 | 1.00 | 2.00 | 2.00 |
| 7 | Powder | 2.00 | 3.00 | 1.00 | 4.00 | 2.50 |
| 8 | Packet | 2.00 | 4.00 | 2.00 | 2.00 | 2.50 |
| 9 | Powder | 3.00 | 3.00 | 2.00 | 3.00 | 2.75 |
| 10 | Powder | 3.00 | 3.00 | 2.00 | 3.00 | 2.75 |
| 11 | Packets | 3.00 | 3.00 | 4.00 | 2.00 | 3.00 |
| 12 | Liquid | 3.00 | 3.00 | 2.00 | 4.00 | 3.00 |
| 13 | Powder | 4.00 | 2.00 | 2.00 | 4.00 | 3.00 |
| 14 | Packet | 4.00 | 4.00 | 3.00 | 2.00 | 3.25 |
| 15 | Packet | 4.00 | 4.00 | 2.00 | 3.00 | 3.25 |
| 16 | Liquid | 4.00 | 4.00 | 2.00 | 3.00 | 3.25 |
| 17 | Liquid | 4.00 | 4.00 | 2.00 | 4.00 | 3.50 |
| 18 | Liquid | 4.00 | 4.00 | 3.00 | 4.00 | 3.75 |

TABLE II

| Comparative | Overall | | | |
|---|---|---|---|---|
| Example | Score | Phosphates | Bleach | Enzymes |
| 1 | 89 | x | | x |
| 2 | 78 | x | x | x |
| 3 | 77 | x | | x |
| 4 | 73 | x | | x |
| 5 | 72 | x | x | x |
| 6 | 65 | | | x |
| 7 | 60 | x | x | |
| 8 | 59 | | x | x |
| 9 | 56 | x | | x |
| 10 | 54 | x | | x |
| 11 | 53 | x | | x |
| 12 | 50 | x | x | |
| 13 | 47 | x | x | |
| 14 | 45 | | | x |
| 15 | 40 | | | x |
| 16 | 37 | | x | |
| 17 | 35 | | x | |
| 18 | 35 | | | x |

Comparative Examples 1-18 are commercially available ADDs for consumer use. Product names for each of the ADDs are shown immediately below. These ADDs are commercially available from a variety of sources, such as grocery stores, pharmacies, etc.

Comparative Example 1 is Cascade® Complete All in 1.

Comparative Example 2 is Finish® Quantum Powerball.

Comparative Example 3 is Cascade® Complete All in 1.

Comparative Example 4 is Finish® All in 1 Powerball Tabs.

Comparative Example 5 is Cascade® with Extra Bleach Action.

Comparative Example 6 is Method® Smarty Dish.

Comparative Example 7 is Finish® Advanced.

Comparative Example 8 is Simplicity® 2 in 1.

Comparative Example 9 is Target®.

Comparative Example 10 is Great Value (Walmart®).

Comparative Example 11 is Finish® all in 1 Gelpacs.

Comparative Example 12 is Sun Light® OxiAction.

Comparative Example 13 is Cascade® with Extra Bleach Action

Comparative Example 14 is Seventh Generation® Free & Clear.

Comparative Example 15 is Palmolive® Eco.

Comparative Example 16 is Sun & Earth®.

Comparative Example 17 is Cascade® with Grease Fighting Power of Dawn®.

Comparative Example 18 is Wave® 2× Ultra High Performance.

The overall scores of the ADDs are based on a 100 point scale where higher values being better. The first ranked ADD is a packet including a phosphate builder and has an overall score of 89 out of 100. On the 100 point scale, as far as overall performance of the respective ADD, a score of 0-20 is considered “poor”, 20-40 is considered “fair”, 40-60 is considered “good”, 60-80 is considered “very good”, and 80-100 is considered “excellent”. In a similar context, the numerical scores, 1.00-5.00, are ranked in a similar, but opposite, fashion. Specifically, 5.00 is considered “poor” (not shown), 4.00 is considered “fair”, 3.00 is considered “good”, 2.00 is considered “very good”, and 1.00 is considered “excellent”, with numbers falling therebetween being borderline between the two respective ratings.

Referring to TABLEs I and II above, the top five performing ADDs all include phosphate builders. In addition, of the top five performing ADDs, only one is in liquid form, which ranks fifth. The next best liquid ADD ranks twelfth, and includes a phosphate builder. The next best liquid ADDs rank sixteenth and seventeenth, both of which are phosphate-free and both include bleach. The next best liquid ADD, which is both phosphate-free and bleach-free ranks last (i.e., eighteenth) and ties for having the worst spotting performance of the eighteen ADDs.

Of the eighteen ADDs, the eighteenth ranked liquid ADD has an overall score of 35 relative to the fifth ranked liquid ADD having an overall score of 72. In other words, the liquid ADD having both phosphate and bleach components (i.e., Comparative Example 5) performs more than twice as well as the phosphate-free and bleach-free liquid ADD (i.e., Comparative Example 18). Notably, the sixteenth ranked liquid ADD only has an overall score of 37, and the seventeenth ranked liquid ADD has an overall score of 35. Also worth noting, all seven of the phosphate-free ADDs only have fair performance with regard to cleaning pots, and five of the seven phosphate-free ADDs only have fair performance with regard to cleaning dishes.

Additional commercially available ADDs are tested to evaluate performance with a focus on spotting and filming performance. The ADDs are tested according to ASTM D 3556-85, which is entitled “Standard Test Method for Deposition on Glassware During Mechanical Dishwashing”, and CSPA DCC-05A, which is entitled “Deposition on Glassware During Mechanical Dishwashing”.

To test the additional ADDs, a conventional household dishwasher is used, specifically, a dishwasher manufactured by Whirlpool®. The respective ADD and an amount of soil are loaded into the dishwasher. The soil includes 72% by weight Blue Bonnet® margarine, 10% by weight lard, and 18% by weight Carnation® powdered milk. Five clean drinking glasses are placed into a top rack of the dishwasher. The dishwasher is run for three cycles. In each cycle, 1.5 gallons of (hard) water is used. The water has a hardness of 200 ppm (based on presence of calcium and magnesium) and a temperature of 120° F. The cycles are described in greater detail below.

Before each of the three cycles, 20 g of the ADD in added to the dishwasher as a “Prewash” load and 20 g of the ADD is added to the dishwasher as a “Normal” load. In addition, before each of the three cycles, 40 g of the soil is added to the dishwasher. After the second cycle, 12 g of Carnation® powdered milk is added to the dishwasher as well. After the third cycle, 15 g of blended raw egg is added to the dishwasher as well. After each of the first and second cycles, each the five glasses are rotated in their respective positions.

After the third cycle completes, the five glasses are removed from the dishwasher. The glasses are visually observed for spotting and filming imparted by the hard water and soil. The glasses are placed into a light box to better observe the presence of spotting and filming. The glasses are each rated on a 1.0-5.0 point scale with regard to filming and spotting performance. Specifically, 5.0 is considered “poor” (not shown), 4.0 is considered “fair”, 3.0 is considered “good”, 2.0 is considered “very good”, and 1.0 is considered “excellent”, with numbers therebetween being borderline between the two respective ratings. The average result of the spotting and filming performance ratings for each group of five glasses is recorded, such that a decimal place is possible.

In TABLE III below, the presence (or absence) of phosphates, bleach, and/or enzymes is reported from labels of the respective ADD. TABLE III includes the average spotting and filming performance results, and the sum thereof, for fourteen comparative ADDs. The symbol ‘x’ indicates the presence of the component.

TABLE III

| Comparative | Type/ | Spot- | Film- | | Phos- | | En- |
|---|---|---|---|---|---|---|---|
| Example | Form | ting | ing | Sum | phates | Bleach | zymes |
| 19 | Packet | 1.0 | 1.4 | 2.4 | x | x | x |
| 20 | Packet | 1.0 | 2.0 | 3.0 | x | | x |
| 21 | Liquid | 1.7 | 1.3 | 3.0 | x | | x |
| 22 | Tablet | 1.5 | 2.0 | 3.5 | | | x |
| 23 | Powder | 2.6 | 1.6 | 4.2 | x | | x |
| 24 | Liquid | 2.8 | 1.8 | 4.6 | x | | x |
| 25 | Liquid | 2.1 | 3.2 | 5.3 | | x | |
| 26 | Packet | 3.8 | 1.8 | 5.6 | x | | x |
| 27 | Liquid | 2.2 | 3.7 | 5.9 | x | x | |
| 28 | Liquid | 2.8 | 3.3 | 6.1 | x | x | |
| 29 | Liquid | 3.7 | 2.4 | 6.1 | x | x | |
| 30 | Liquid | 3.0 | 3.2 | 6.2 | | x | |
| 31 | Powder | 3.6 | 2.7 | 6.3 | x | x | |
| 32 | Liquid | 4.0 | 4.0 | 8.0 | | x | |

Comparative Examples 19-32 include commercially available ADDs for consumer use. Product names for each of the ADDs are shown immediately below. These ADDs are commercially available from a variety of sources, such as grocery stores, pharmacies, etc.

Comparative Example 19 is Electrasol® Quantum Gel Pac.

Comparative Example 20 is Cascade® All in One (packet).

Comparative Example 21 is Cascade® Complete with Bleach Hydroclean Action.

Comparative Example 22 is Method® Smarty Dish.

Comparative Example 23 is Cascade® Complete.

Comparative Example 24 is Cascade® Complete All in One (gel).

Comparative Example 25 is Palmolive® Eco+.

Comparative Example 26 is Electrasol® (Finish®) Gel Pac.

Comparative Example 27 is Electrasol® Advanced Gel.

Comparative Example 28 is Sunlight® Oxiaction.

Comparative Example 29 is Cascade® with Extra Bleach Action.

Comparative Example 30 is Cascade® with Baking Soda.

Comparative Example 31 is Finish® (Electrasol®).

Comparative Example 32 is Cascade® with Dawn®.

Referring to the TABLE III above, the top three performing ADDs all include phosphate builders. The best performing liquid ADD includes a phosphate builder. All of the phosphate-free liquid ADDs include bleach.

Examples of the detergent composition of the present invention are prepared and tested. Testing is carried out in the same manner as described for Comparative Examples 19-32. To form the detergent compositions, the components of the detergent compositions are blended in a vessel until a homogenous solution is obtained.

The amount and type of each component used to prepare the detergent compositions are indicated in TABLE IV below with all values in percent by weight based on the total weight of the respective detergent compositions unless otherwise indicated. The symbol ‘-’ indicates that the property was not measured.

TABLE IV

| Example | 33 | 34 | 35 | 36 |
|---|---|---|---|---|
| Component | | | | |
| Chelating 1 | 3.00 | 10.00 | 5.00 | 12.50 |
| Metal Citrate | 0.00 | 10.00 | 5.00 | 5.00 |
| Citric Acid | 0.00 | 0.00 | 4.90 | 9.80 |
| Metal Carbonate | 10.00 | 0.00 | 0.00 | 0.00 |
| Builder 1 | 5.91 | 5.00 | 5.70 | 0.00 |
| Builder 2 | 0.00 | 0.00 | 0.00 | 13.00 |
| Polymeric Dispersant | 1.33 | 2.00 | 2.00 | 4.40 |
| Thickener | 1.20 | 1.00 | 1.20 | 1.00 |
| Nonionic Surfactant | 2.00 | 1.50 | 2.00 | 2.00 |
| Filler | 7.30 | 7.30 | 0.00 | 0.00 |
| Borax | 0.00 | 2.00 | 0.00 | 0.00 |
| Enzyme 1 | 0.00 | 0.00 | 0.30 | 0.30 |
| Enzyme 2 | 0.00 | 0.00 | 1.00 | 1.00 |
| Water | 56.17 | 61.20 | 72.90 | 51.00 |
| Total | 86.91 | 100.00 | 100.00 | 100.00 |
| Testing | | | | |
| pH | 11.00 | 11.80 | 8.25 | — |
| Viscosity (Cps) | 5350 | 2450 | 7800 | — |
| Spotting | 3.1 | 2.5 | 3.2 | — |
| Filming | 2.1 | 2.4 | 3.1 | — |
| Sum | 5.2 | 4.9 | 6.3 | — |

Chelating 1 is an aqueous chelating component comprising 40% by weight Na₃.MGDA and 60% by weight water, commercially available from BASF Corporation of Florham Park, N.J.

Metal Citrate is sodium citrate.

Citric acid is a 50 weight percent (wt. %) aqueous solution.

Metal Carbonate is sodium carbonate.

Builder 1 is sodium metasilicate.

Builder 2 is a 44 wt. % aqueous solution comprising sodium silicate.

Polymeric Dispersant is a low molecular weight polyacrylic acid, partially hydrolyzed as the sodium salt, 30% percent active by weight, and has 48-50% solids by weight, the reminder being water, commercially available from BASF Corporation.

Thickener is a highly crosslinked polyacrylic acid polymer, commercially available from Lubrizol Corporation of Wickliffe, Ohio.

Nonionic Surfactant is an alcohol alkoxylate, commercially available from BASF Corporation.

Filler is sodium sulfate.

Enzyme 1 is amylase, commercially available from Danisco A/S of Copenhagen, Denmark.

Enzyme 2 is protease, commercially available from Danisco A/S.

Viscosities of each of the examples are determined at −21° C. (70° F.) with a Brookfield viscometer set at a speed of 30 RPM, using a #2 spindle.

In the examples above, it can be appreciated that there is a relationship or synergy between Chelating 1 and metal citrate, especially with regard to spotting and filming performance of the detergent compositions. The presence or lack of metal carbonate in the detergent compositions can also be appreciated.

Thirteen additional detergent compositions are prepared and tested. Testing is carried out in the same manner as described for Comparative Examples 19-32. The respective components, if present, are the same as described above for Examples 33-36.

The amount and type of each component used to prepare the detergent compositions are indicated in TABLEs V and VI below with all values in percent by weight based on the total weight of the respective detergent compositions unless otherwise indicated.

TABLE V

| | Example | | | | | | |
|---|---|---|---|---|---|---|---|
| | 37 | 38 | 39 | 40 | 41 | 42 | 43 |
| Component | | | | | | | |
| Chelating 1 | 26.80 | 13.20 | 0.00 | 13.33 | 0.00 | 13.20 | 26.80 |
| Metal Citrate | 13.20 | 26.80 | 0.00 | 13.33 | 40.00 | 0.00 | 0.00 |
| Metal Carbonate | 0.00 | 0.00 | 40.00 | 13.33 | 0.00 | 26.80 | 13.20 |
| Builder 1 | 5.00 | 5.00 | 5.00 | 5.00 | 5.00 | 5.00 | 5.00 |
| Polymeric Dispersant | 4.44 | 4.44 | 4.44 | 4.44 | 4.44 | 4.44 | 4.44 |
| Nonionic Surfactant | 1.50 | 1.50 | 1.50 | 1.50 | 1.50 | 1.50 | 1.50 |
| Filler | 49.06 | 49.06 | 49.06 | 49.06 | 49.06 | 49.06 | 49.06 |
| Total | 100.0 | 100.0 | 100.0 | 100.0 | 100.0 | 100.0 | 100.0 |
| Testing | | | | | | | |
| Spotting | 3.1 | 2.5 | 3.2 | 3.1 | 4.2 | 3.2 | 3.6 |
| Filming | 2.1 | 2.4 | 3.1 | 2.2 | 2.7 | 2.3 | 2.7 |
| Sum | 5.2 | 4.9 | 6.3 | 5.3 | 6.9 | 5.5 | 6.3 |

TABLE VI

| | Example | | | | | |
|---|---|---|---|---|---|---|
| | 44 | 45 | 46 | 47 | 48 | 49 |
| Component | | | | | | |
| Chelating 1 | 40.00 | 0.00 | 0.00 | 8.00 | 8.00 | 24.00 |
| Metal Citrate | 0.00 | 26.80 | 13.20 | 24.00 | 8.00 | 8.00 |
| Metal | 0.00 | 13.20 | 26.80 | 8.00 | 24.00 | 8.00 |
| Carbonate | | | | | | |
| Builder 1 | 5.00 | 5.00 | 5.00 | 5.00 | 5.00 | 5.00 |
| Polymeric | 4.44 | 4.44 | 4.44 | 4.44 | 4.44 | 4.44 |
| Dispersant | | | | | | |
| Nonionic | 1.50 | 1.50 | 1.50 | 1.50 | 1.50 | 1.50 |
| Surfactant | | | | | | |
| Filler | 49.06 | 49.06 | 49.06 | 49.06 | 49.06 | 49.06 |
| Total | 100.0 | 100.0 | 100.0 | 100.0 | 100.0 | 100.0 |
| Testing | | | | | | |
| Spotting | 4.0 | 3.5 | 3.6 | 3.4 | 3.5 | 3.4 |
| Filming | 2.3 | 1.9 | 2.1 | 2.5 | 2.7 | 2.3 |
| Sum | 6.3 | 5.4 | 5.7 | 5.9 | 6.2 | 5.7 |

Two separate sets of thirteen additional examples of detergent compositions are also prepared and tested in the same manner as Examples 37-49. In the first set, thirteen inventive compositions are the same as Examples 37-49, except that Chelating 1 is replaced with Chelating 2. Chelating 2 includes 47% by weight GLDA and 53% by weight water. In the second set, thirteen comparative compositions are the same as Examples 37-49, except that Chelating 1 is replaced with Chelating 3. Chelating 3 includes 100% by weight STPP. It is necessary to compare filming and spotting performance on an equivalent active wt. % basis due to the mixture design nature of this experimentation.

Based on the spotting and filming results presented in TABLES V and VI above, and spotting and filming results gathered for the two additional sets of examples employing GLDA and STPP, models are developed to illustrate whether a synergistic relationship exists between the respective chelating component, metal citrate, and metal carbonate. One model is developed with regard to spotting performance and one model is developed with regard to filming performance.

The models (or conditions) developed from the examples are illustrated below:

X=2.29111957358269*a1+2.51239058900997*a2+2.25856942594569 b+2.74653793438369*c+3.6715652552351*d+a1*b*−0.153746554406015+a2*b*0.258373756307274+b*d*2.10656856923322+a2*c*1.33450322482691+c*d*1.53334203757727; and

Y=4.00296307306122*a1+3.75836351714502*a2+3.69929876101964 b+3.09694503312483*c+2.55922155006316*d+a1*b*−4.10606106049733+a2*b*−1.53777005751939+b*d*2.46987618393733+a2*c*0.965090802880752+c*d*4.12606235087258.

In the X and Y conditions above, X illustrates filming performance of the detergent compositions, and Y illustrates spotting performance of the detergent compositions. Further, a1 is the weight fraction of Chelating 1 (i.e., MGDA), a2 is the weight fraction of Chelating 2 (i.e., GLDA), b is the weight fraction of the Metal Citrate, c is the weight fraction of the Metal Carbonate, and d is the weight fraction of Chelating 3 (i.e., STPP), wherein the weight fractions are based on the total amount of the chelating components, metal citrate and metal carbonate present in the detergent compositions (which is 40 parts by weight based on 100 parts by weight of the detergent composition in Examples 37 through 49 above). Variables (or confines) X and Y, as well as a1, a2, b, and c and the X and Y conditions of the present invention, in general, and calculations employing the same, are described in detail above in the DETAILED DESCRIPTION OF THE INVENTION section and are not repeated here for sake of brevity.

The X and Y conditions can be simplified by numerically rounding the weighting factors to various decimal places, such as the conditions illustrated below which include weighting factors numerically rounded to their second decimal place:

X=2.29*a1+2.51*a2+2.26*b+2.75*c+3.67*d+a1*b*−0.15+a2*b*0.26+b*d*2.11+a2*c*1.33+c*d*1.53; and

Y=4.00*a1+3.76*a2+3.70*b+3.10*c+2.56*d+a1*b*−4.11+a2*b*−1.54+b*d*2.47+a2*c*0.97+c*d*4.13.

As can be appreciated from the X and Y conditions above, each component of the detergent composition can be compared against the other based on its respective weighting factor present in the X or Y condition. It is to be appreciated that the weighting factors can be numerically rounded to higher or lower decimal places.

Ranking the components in the X condition(s), in order of increasing weighting factors for the individual weight fractions, and therefore, in order of least detriment to highest detriment of filming performance imparted to the detergent composition, Metal Citrate ranks first, Chelating 1 ranks second, Chelating 2 ranks third, Chelating 3 ranks fourth, and Metal Carbonate ranks fifth. As such, it can be appreciated that metal citrate and Chelating 1 are least detrimental to detergent compositions including the same with regard to filming performance.

More notably, with reference to the X condition(s) above, it can be appreciated that a synergy exists between metal citrate and Chelating 1, where a negative weighting factor exists between the product of weight fractions a1 and b. The negative weighting factor lowers X, which is desirable for the reasons described above. Conversely, each of the weighting factors for the products of weight fractions a2 and b and weight fractions b and d are each positive, which is to the detriment of the detergent composition (by increasing X). Said another way, the presence of Chelating 2 and/or 3 in combination with metal citrate has a negative effect on filming performance of the detergent composition.

Ranking the components in the Y condition, in order of increasing weighting factors for the individual weight fractions, and therefore, in order of least detriment to highest detriment of spotting performance imparted to the detergent composition, Chelating 3 ranks first, Metal Carbonate ranks second, Metal Citrate ranks third, Chelating 2 ranks fourth, and Chelating 1 ranks fifth. As such, it can be appreciated that in a phosphorus-free detergent composition, i.e., one lacking Chelating 3, metal carbonate and metal citrate are least detrimental to detergent compositions including the same with regard to spotting performance.

More notably, with reference to the Y condition(s) above, it can be appreciated that a synergy exists between metal citrate and Chelating 1, where a negative weighting factor exists between the product of weight fractions a1 and b. The negative weighting factor greatly lowers Y, which is desirable for the reasons described above. The same is generally true for Chelating 2. Conversely, the weighting factor for the product of weight fractions b and d is positive, which is to the detriment of the detergent composition (by increasing Y). Said another way, the presence of Chelating 3 in combination with metal citrate has a negative effect on spotting performance of the detergent composition.

With regard to Chelating 2 and the Y condition, it can be appreciated that a synergy exists between metal citrate and Chelating 2, where a negative weighting factor exists between the product of weight fractions a2 and b. The negative weighting factor lowers Y, which is desirable; however, the negative weighting factor is smaller than that of the product of weight fractions a1 and b.

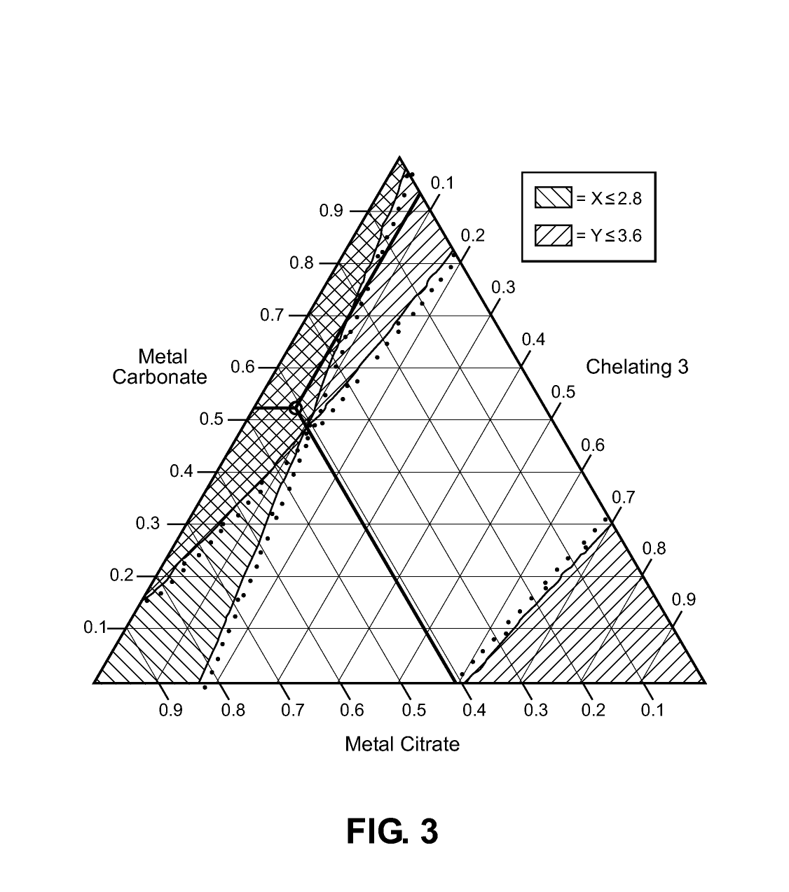

Referring now to the Figures, FIG. 1 illustrates a ternary plot of X and Y conditions when a2 and d are each set to zero (i.e., Chelatings 2 and 3 are both excluded), X is ≦2.5, and Y is ≦3.0. FIG. 2 illustrates a ternary plot of the X and Y conditions when a1 and d are each set to zero (i.e., Chelatings 1 and 3 are both excluded), X is to ≦2.5, and Y is to ≦3.4. FIG. 3 illustrates a ternary plot of the X and Y conditions when a1 and a2 are each set to zero (i.e., Chelatings 1 and 2 are both excluded), X is ≦2.8, and Y is ≦3.6. In each of FIGS. 1 through 3, “Metal Carbonate” is sodium carbonate, and “Metal Citrate” is sodium citrate, with the each of Chelating 1, 2, and 3 being as described and exemplified above.

In each of the ternary plots, the respective b, c, and a1, a2, or d weight fractions can be determined by picking a point in the darkest region(s) of the plot, indicated as the region including the cross-hair. The weight fractions for each of the components can then be used to determine the total amount of each component present in the detergent composition based on the total amount of the respective chelating component, metal citrate and sodium carbonate present in the detergent composition. As just one example, the total amount of the respective chelating component, metal citrate and sodium carbonate can be set to 40 parts by weight, and inserted into detergent compositions similar to Examples 37 through 49, based on 100 parts by weight of the detergent compositions. Various ternary plots can be generated with the X and Y conditions, by choosing X and Y threshold values. Performance differences between the different chelating components can be appreciated by comparing and contrasting overlapping and non-overlapping regions of their respective ternary plots.

The X and Y conditions of the present invention are able to accurately predict spotting and filming performance of the detergent compositions when employing specific weight fractions of the respective chelating component, metal citrate, and sodium carbonate. The amounts of each component for desired X and Y performance values can then be determined by solving the conditions for each of the variables. It is to be appreciated that either weight fraction a1, a2, or d can be set as being greater than zero with the remaining a1, a2, or d being set to zero. Alternatively, two or all three of a1, a2, or d can be set as greater than zero, with the remaining a1, a2, or d being set to zero, if any remain.

Typically, for purposes of the present invention, weight fraction d is set to zero, more typically weight fractions a2 and d are each set to zero, such that the conditions, when in simplified form are:

X=2.29*a1+2.26*b+2.75*c+a1*b*−0.15; and

Y=4.00*a1+3.70*b+3.10*c+a1*b*−4.11.

In view of the foregoing X and Y conditions and description thereof, it can be appreciated that each of Chelatings 1, 2 and 3 each are different. It is believed that although each of the chelating components is traditionally believed to be functional equivalents of one another with respect to interaction(s) with metal citrate and/or sodium carbonate, the detergent compositions of the present invention illustrate that this is not true. Notably, a synergy exists between metal citrate and chelating components comprising MGDA and/or an alkali salt thereof, with regard to filming and spotting performance of detergent compositions including the same. The same is generally true for GLDA and/or an alkali salt thereof.

The detergent compositions of the present invention have excellent filming and spotting performance relative to detergent compositions employing other chelating components, such as STPP. Specifically, the present invention provides detergent compositions that are free of phosphorus-containing components, which perform competitively, if not better, than conventional detergent compositions including phosphate builders. In addition, the detergent compositions of the present invention perform competitively, if not better, than commercially available phosphorus-free detergent compositions.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The invention may be practiced otherwise than as specifically described within the scope of the appended claims.

1. A detergent composition comprising:
A) a chelating component comprising;
a1) methylglycine-N—N-diacetic acid (MGDA) and/or an alkali salt thereof, and/or
a2) N,N-bis(carboxymethyl)-L-glutamate (GLDA) and/or an alkali salt thereof;
B) a metal citrate; and
C) a metal carbonate;
wherein the total amount of said chelating component A), metal citrate B) and metal carbonate C) present in said detergent composition is no greater than about 50 parts by weight based on 100 parts by weight of said detergent composition, and at least one of the following two conditions is true,
i) X=(2.29*a1)+(2.51*a2)+(2.26*b)+(2.75*c)+(−0.15*a1*b)+(0.26*a2*b)+(1.33*a2*c), and/or
ii) Y=(4.00*a1)+(3.76*a2)+(3.70*b)+(3.10*c)+(−4.11*a1*b)+(−1.57*a2*b)+(0.97*a2*c);
wherein
iii) 0<X≦2.5,
iv) 0<Y≦3.5,
v) at least one of a1 and a2 is greater than zero and less than 1.0,
vi) b is greater than zero and less than 1.0,
vii) c ranges from zero to less than 1.0, and
viii) a1+a2+b+c=1.0; and
wherein X is the filming performance of said detergent composition, Y is the spotting performance of said detergent composition, a1 is the weight fraction of said chelating component a1), a2 is the weight fraction of said chelating component a2), b is the weight fraction of said metal citrate B), and c is the weight fraction of said metal carbonate C), and wherein the weight fractions are based on the total amount of said chelating component A), metal citrate B) and metal carbonate C) present in said detergent composition.

2. A detergent composition as forth in claim 1 wherein at least one of the following four conditions is true: 0.250≦a1≦0.675; 0.275≦a2≦0.675; 0.325≦b≦0.750; and/or 0<c≦0.175.

3. A detergent composition as set forth in claim 1 wherein at least one of the following two conditions is true: 0<X≦2.25; and/or 0<Y≦3.25.

4. A detergent composition as set forth in claim 1 wherein the weight fraction of said chelating component a2) is zero and wherein:
X=(2.29*a1)+(2.26*b)+(2.75*c)+(−0.15*a1*b); and
Y=(4.00*a1)+(3.70*b)+(3.10*c)+(−4.11*a1*b).

5. A detergent composition comprising:
A) a chelating component comprising methylglycine-N—N-diacetic acid (MGDA) and/or an alkali salt thereof;
B) a metal citrate;
C) a metal carbonate;
wherein the total amount of said chelating component A), metal citrate B) and metal carbonate C) present in said detergent composition is no greater than about 50 parts by weight based on 100 parts by weight of said detergent composition, and at least one of the following two conditions is true,
i) X=(2.29*a)+(2.26*b)+(2.75*c)+(−0.15*a*b), and/or
ii) Y=(4.00*a)+(3.70*b)+(3.10*c)+(−4.11*a*b);
wherein
iii) 0<X≦2.5,
iv) 0<Y≦3.5,
v) 0.250<a<0.675,
vi) 0.325<b<0.750,
vii) 0<c<0.175, and
viii) a+b+c=1.0; and
wherein X is the filming performance of said detergent composition, Y is the spotting performance of said detergent composition, a is the weight fraction of said chelating component A), b is the weight fraction of said metal citrate B), and c is the weight fraction of said metal carbonate C), and wherein the weight fractions are based on the total amount of said chelating component A), metal citrate B) and metal carbonate C) present in said detergent composition;
D) a builder;
E) a nonionic surfactant;
F) a polymeric dispersant; and, optionally,
G) a filler.

6. A detergent composition as forth in claim 1 wherein the total amount of said chelating component A), metal citrate B) and metal carbonate C) present in said detergent composition is no greater than about 45 parts by weight based on 100 parts by weight of said detergent composition.

7. A detergent composition as set forth in claim 1 wherein the total amount of said chelating component A), metal citrate B) and metal carbonate C) present in said detergent composition is from about 35 to about 45 parts by weight based on 100 parts by weight of said detergent composition.

8. A detergent composition as set forth in claim 1 wherein said chelating component A) comprises Na₃.MGDA.

9. A detergent composition as set forth in claim 8 wherein said chelating component A) is aqueous and said Na₃.MGDA is present in said chelating component A) in an amount of from about 35 to about 45 parts by weight based on 100 parts by weight of said chelating component A).

10. A detergent composition as set forth in claim 5 wherein at least one of the following four conditions is true:
said builder D) is sodium silicate, and said sodium silicate is present in said detergent composition in an amount of from about 1 to about 40 parts by weight based on 100 parts by weight of said detergent composition;
said nonionic surfactant E) is an alcohol alkoxylate, and said alcohol alkoxylate is present in said detergent composition in an amount of from about 1 to about 15 parts by weight based on 100 parts by weight of said detergent composition;
said polymeric dispersant F) is polyacrylic acid, and said polyacrylic acid is present in said detergent composition in an amount of from about 1 to about 15 parts by weight based on 100 parts by weight of said detergent composition; and/or
said filler is a metal sulfate, and said metal sulfate is present in said detergent composition in an amount of from about 10 to about 90 parts by weight based on 100 parts by weight of said detergent composition.

11. A detergent composition as set forth in claim 1 further comprising an enzyme component comprising a protease, an amylase, a lipase, a cellulase, a peroxidase, or combinations thereof.

12. A detergent composition as set forth in claim 11 wherein said enzyme component is present in said detergent composition in an amount of from about 0.1 to about 3 parts by weight based on 100 parts by weight of said detergent composition.

13. A detergent composition comprising:
A) a chelating component comprising methylglycine-N—N-diacetic acid (MGDA) and/or an alkali salt thereof;
B) a metal citrate;
C) a metal carbonate;
wherein the total amount of said chelating component A), metal citrate B) and metal carbonate C) present in said detergent composition is from about 35 to about 45 parts by weight, said chelating component A) is present in said detergent composition in an amount of from about 30 to about 70 parts by weight, said metal citrate B) is present in said detergent composition in an amount of from about 30 to about 70 parts by weight, said metal carbonate C) is present in said detergent composition in an amount of from about 10 to about 30 parts by weight, each based on 100 parts by weight of said detergent composition;
D) sodium silicate;
E) an alcohol alkoxylate;
F) polyacrylic acid; and
G) a metal sulfate.

14. A detergent composition as set forth in claim 1 wherein at least one of the following five conditions is true:
said detergent composition is free of a phosphorus-containing component;
said detergent composition is free of a linear alkylbenzene sulfonate;
said detergent composition is free of a chlorine-containing component;
said detergent composition is free of a bleach component; and/or
said detergent composition is free of an anionic surfactant.

15. A detergent composition as set forth in claim 1 wherein said metal citrate B) is sodium citrate.

16. A detergent composition as set forth in claim 1 wherein said metal carbonate C) is sodium carbonate.

17. A detergent composition as set forth in claim 1 that is further defined as a liquid automatic dishwashing detergent.

18. A detergent composition as set forth in claim 17 having a viscosity of from about 500 to about 15,000 cP at 25° C.

19. A detergent composition as set forth in claim 1 wherein said metal citrate B) is sodium citrate and said metal carbonate C) is sodium carbonate.

20. A detergent composition as set forth in claim 5 wherein said metal citrate B) is sodium citrate and said metal carbonate C) is sodium carbonate.

21. A detergent composition as set forth in claim 13 wherein said metal citrate B) is sodium citrate and said metal carbonate C) is sodium carbonate.
